(19) United States
(12) Patent Application Publication
(10) Pub. No.: US 2012/0253857 A1
(43) Pub. Date: Oct. 4, 2012

(54) STRUCTURED METHODS FOR BUSINESS PROCESS UNIFICATION

(75) Inventors: Deepak Mandot, Bangalore (IN); Hemal Shah, Maharashtra (IN)

(73) Assignee: INFOSYS TECHNOLOGIES LIMITED, Bangalore (IN)

(21) Appl. No.: 13/073,338

(22) Filed: Mar. 28, 2011

(51) Int. Cl. G06Q 10/00

(52) U.S. Cl. 705/7.11; 705/1.1

(57) ABSTRACT

The proposed disclosure relates to a computer aided method for the implementation of process unification across regionally distributed process environments. The method includes the establishment of a process framework. It further includes the creation of a present state model for each regionally distributed process environment and the creation of a unified future state model. The normalization of the future state model across the regionally distributed process environments is also called for. Some aspects of the method may include the use of computer based tools in the establishment of the process framework, the establishment of the present state model and the establishment of the future state model.

### BACKGROUND

The invention relates generally to the field of business process unification. In particular, the invention relates to methods of deploying a unified process model across a variety of regionally distributed process environments.

As a large scale organization diversifies across geographical boundaries, its need to establish a coherent workflow that is responsive to unitary executive control increases. Such a need may be addressed by means of business process unification.

When effectively implemented, process unification may serve to increase an organization's competitiveness by allowing it to implement a common global process model across its various regional centers while retaining regional best practices. Such an organization may also, following the implementation of a coherent process unification model, leverage selected regional processes at a global scale. A further benefit is that shifting from department or regional oriented process environments to the kind of end to end process ownership enabled by effective process unification ultimately helps the organization become more agile and customer centric.

While there have been previous instances of the implementation of process unification, these methods have lacked the inclusion of business transformational considerations that are required when moving from a multiple region, multiple process environment to a common, unified process. Notably, extant methods do not provide a comprehensive and structured step by step shift from legacy processes to a unified and streamlined process model. There remains a gap in the field, therefore, for a structured and quantifiable method of implementation of process unification.

Specifically, methods that contain pre-defined metrics, such as time measures that track process changes, clear classification of process levels, and ownership and accountability at each of these process levels, are necessary. Such measures, effectively implemented, may provide clarity while providing a roadmap for change. These elements, then, together provide a set of key determinants of a successful shift toward a standard process model, and they are not clearly addressed as a coherent whole in the field.

Accordingly there is a need for a structured method for implementing process standardization in a plurality of regionally distributed environments that takes into account the above factors, among others.

### SUMMARY

The present invention is directed to methods for implementing process unification across regionally distributed process environments. A method described includes the establishment of a common process framework. The method also includes the establishment of at least one present state model for the regionally distributed process environments and the establishment of a future state model. The method further includes the normalization of the future state model across the regionally distributed process environments.

In an aspect of the present implementation, the establishment of the common process framework may include classifying processes across the regionally distributed process environments into at least two process levels. Such an aspect further includes mapping a transaction flow for each of the at least two process levels using a computer and assigning an ownership role to each of the at least two process levels.

In an additional aspect, the establishment of the at least one present state model may include the creation of a reference model for each transaction flow mapped to each of the at least two process levels, where the reference model is captured in a computer based template. It further includes identification of process requirements associated with each of the transaction flows and identification of best practices for processes within each of the at least two process levels. Additional steps may include identification of at least one pain point, wherein a pain point is an existing limitation within a process that is under consideration, and the drafting of a final common requirements document, such a final common requirements document detailing identified requirements and including the at least one pain point associated with each of the at least one present state models.

In another aspect, the establishment of the future state model may include collation of processes in each of the at least two process levels across the regionally distributed process environments and identification of commonality in the processes under comparison. It further includes the assignment of a commonality rating for each process as well as the classification of processes in each of the at least two process levels on the basis of the commonality rating for each process. The aspect under consideration may also call for the incorporation of a solution to the at least one pain point identified in the present state model into the future state model and, finally, the alignment of requirements for each of the at least two process levels with strategic business objectives and the generation of at least one requirement for the future state model thereby.

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 is a block diagram of a method of process unification in accordance with a presented embodiment.

FIG. 2 is a block diagram of a method for establishing a process framework, in accordance with a presented embodiment.

FIG. 3 is a block diagram of a method for establishing a present state model, in accordance with a presented embodiment.

FIG. 4 is a block diagram of a method for establishing a future state model, in accordance with a presented embodiment.

FIG. 5 is an illustrative diagram of the establishment of a commonality rating, as disclosed in some embodiments.

### DETAILED DESCRIPTION

The disclosed application is directed toward implementations of a method for implementing process unification across regionally distributed process environments, and the following description is the full and informative description of the best method presently contemplated for carrying out the present invention which is known to the inventors at the time of filing the patent application. Of course, many modifications and adaptations will be apparent to those skilled in the relevant arts in view of the following description and the accompanying drawings and appended claims. While the methods described herein are provided with a certain degree of specificity, the present technique may be implemented with either greater or lesser specificity, depending on the needs of the user. As such, the present description should be considered as merely illustrative of the principles of the present technique and not in limitation thereof, since the present technique is defined solely by the claims.

In describing implementations of a method for process unification, the term process is generally referred to as being a series of tasks or activities that produce a product or service.

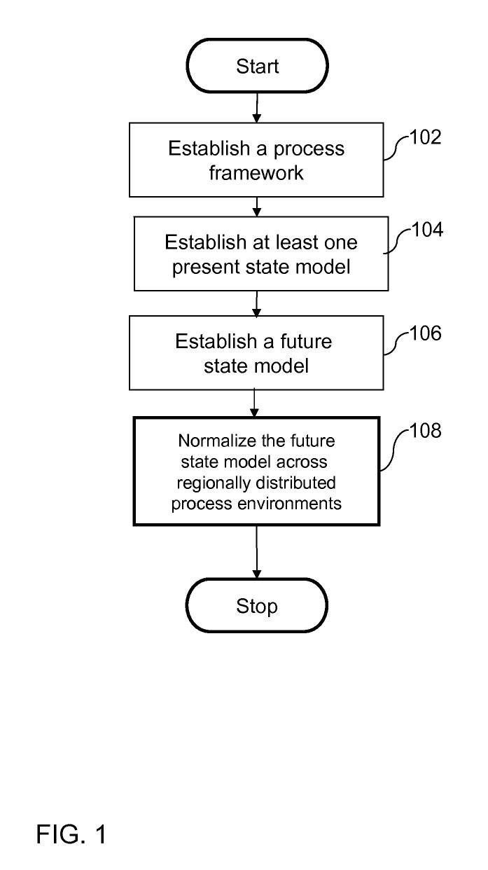

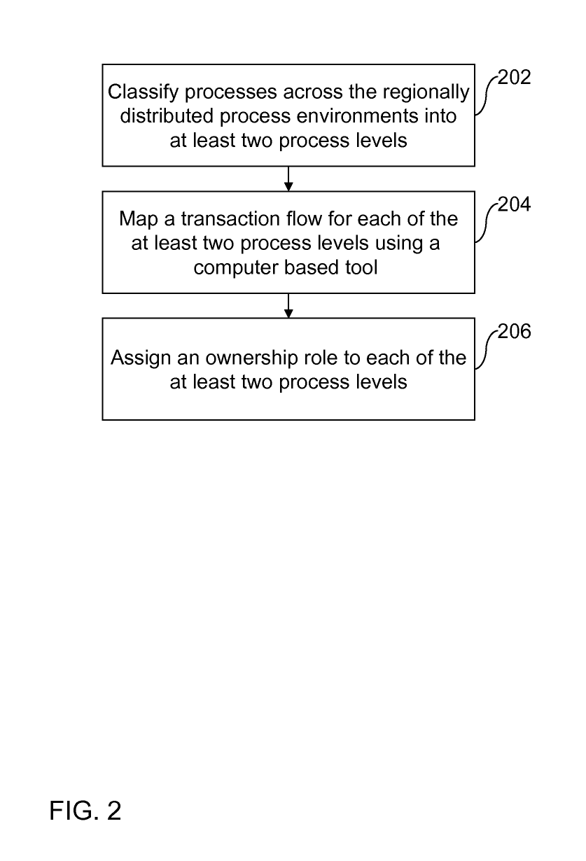

Referring specifically now to FIG. 1, the method includes the step as shown in block 102, of establishing a process framework. The establishment of a process framework is further detailed in FIG. 2, where, as shown in block 202, processes in the regionally distributed process environments are classified into at least two process levels. As many as five process levels may be defined in some implementations, and these five process levels classified further, for example, into a sequentially numbered list denoted by L0, L1, L2, L3 and L4.

A purpose of the decomposition of extant processes in an organization into such process levels is to create a logical hierarchy around which a suitable process unification model may be tailored. As an example, an organization in a manufacturing and distribution environment may choose to classify resource procurement, solution development and customer development, among other high level process, as core or enterprise level processes, and assign them to a top level L0. These processes are then mapped onto a transaction flow that depicts each of the process levels, as shown in block 204. A second process level, such as L1, then, may be held to define the start, end and boundary of each of these transactional flows.

Descending this hierarchy, a third process level, L2, may map detailed role-wise activities required to complete a specific L1 transactional flow. In such an instance, L2 processes may include multiple activities or steps that can be logically grouped to be represented in, for example, a flow diagram. A subsequent process level, L3, may contain detailed business requirements, logic and rules around each activity in L2. In some embodiments, a final process level that maps exceptions to general business rules around which higher process levels operate may be included, generally as L4.

An ownership role may also be assigned for each process level, as in block 206. Assigning clear ownership and expectations from different roles at a regional and a global level is a significant aspect of a successful implementation. Some roles may include top level, sometimes denoted as L0, process ownership. Top level process ownership may generally be assigned to, for example, the executive management of the organization. Other possible roles assigned include global transaction flow owners who work as facilitators across regions and regional transaction flow owners who may highlight regional differentiators and ensure the feasibility of, and alignment with, the unified process model in their respective regions.

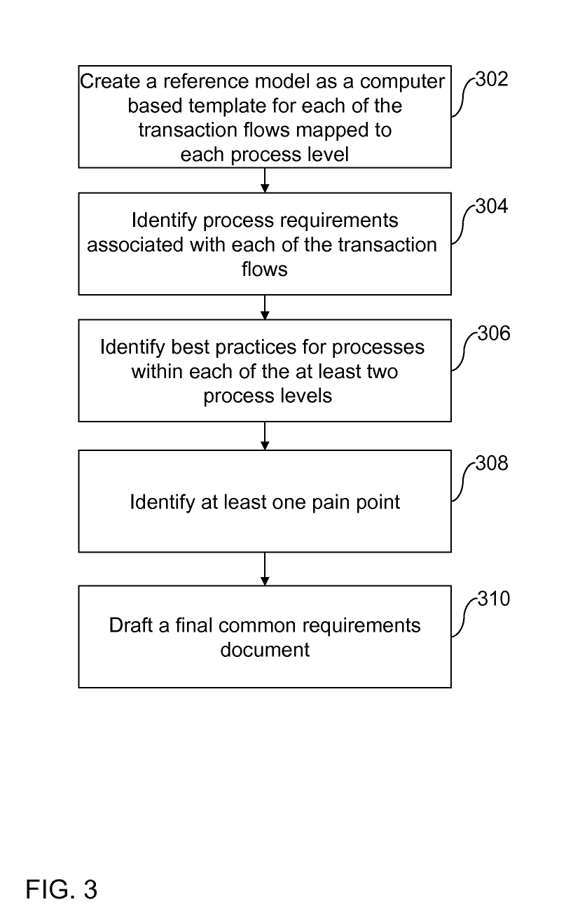

Referring back to FIG. 1, block 102 illustrates the next step in the implementation of a unified process model, which is the establishment of present state models for the distributed process environments. The establishment of a present state model is further detailed in FIG. 3, where, as in a block 302, a reference model for each of the transaction flows mapped to the previous listed process levels is created. A purpose of building reference models for each transaction flow is to ensure greater coverage of business requirements gathering as well as a consistent level of detail in defining requirements and transaction flows across regions. In addition, detailed reference model capture is vital in the preservation of the integrity of a future state model on which it is based.

In a preferred embodiment, a computer based process modeling tool may be used to capture requirements or make modifications to the reference model, which is then mapped or captured as a template. Then, as in a block 304, process requirements associated with each of the transaction flows are identified. For a given transaction flow associated with a process level, detailed business requirements and exceptions pertaining to that transaction flow in lower process levels may be captured. In some embodiments such requirements capture may preferably be in the form of statements, rather than free flow text. In addition, requirements associated with lower level transaction flows, particularly those transaction flows that are specific to a regional process environment are preferably captured with a high level of detail. For example, while, in a preferred embodiment, a high level L2 transaction flow may be relatively consistent across multiple regions, L3 and L4 requirements associated with the same L2 transaction may differ across regions, thereby increasing the importance of detail in the corresponding requirements capture. For these reasons, a preferred embodiment may involve the use of a computer based process modeling tool to perform requirements capture.

In some embodiments, requirements critical to a least one customer are identified. Customers to whom a particular requirements capture is tailored may be internal or external to the organization. Such a step aids in the identification of areas of value during the preparation of a future state model.

Some embodiments may also include the step of performing value-add analyses of existing processes within the present state model. Such analyses may be conducted from the perspective of a previously identified customer, and would thusly seek to integrate the points of view of all stakeholders for the process. A further value-add analysis may be performed for the purpose of evaluating the internal performance of a particular process through such mechanisms as process monitoring and measurement. A final value-add analysis that may be performed is a non-value add analysis, where any steps that exist in the process but do not add any significant value either to a customer or to the internal controls of the organization are identified. Such steps may then be targeted for elimination in the preparation of a future state model.

Additionally, the measurement of a time elapsed in the completion of each process stage at various higher order process levels is also indicated in a preferred embodiment. Best practices for processes within each process level are also identified, as in block 306. A further step in the establishment of a present state model, as in block 308, involves the identification of at least one pain point. Pain points may be explained as being the existing challenges in a process, and they are usually identified by a business team or a process owner responsible for oversight of the process. In a preferred embodiment, identified pain points are rated in order of priority, where, in an example, the elimination of a pain point given a high rating may yield a relatively large improvement in process efficiency. A final step disclosed by block 312 involves the drafting of a final requirements document.

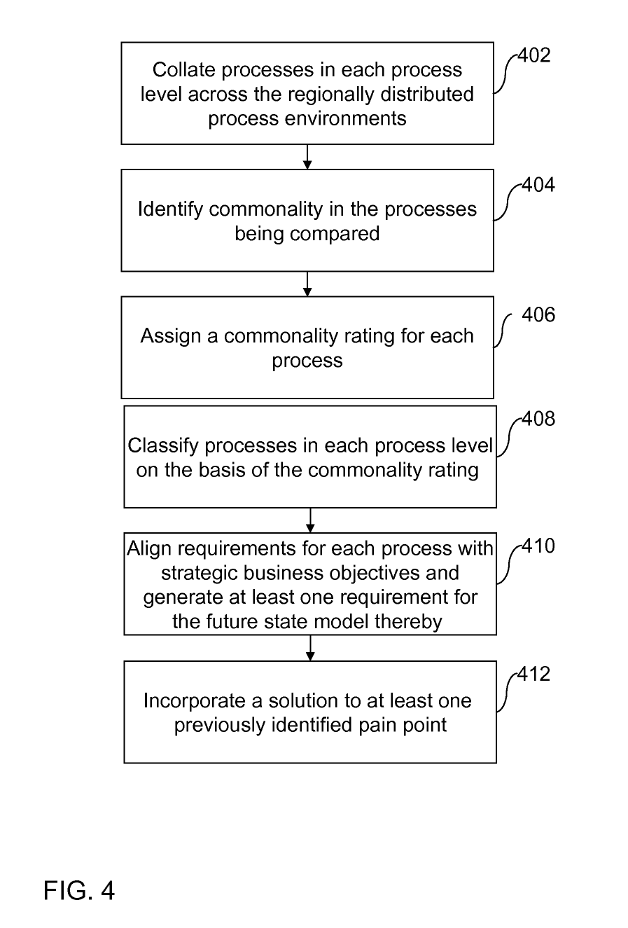

The next step in the establishment of a unified process model, as disclosed in FIG. 1, is shown in a block 106, which involves the establishment of a future state model that is built from the disparate regional present state models. A process involved in such a step is detailed in FIG. 4. Referring now to FIG. 4, a block 402, as shown, calls for collation of processes in each process level across the regionally distributed process environments. The collation of process data by process level may be performed in a common tool such as, in a preferred embodiment, a computer based spreadsheet tool. Each business process and requirement identified may be listed in the spreadsheet and sorted by region.

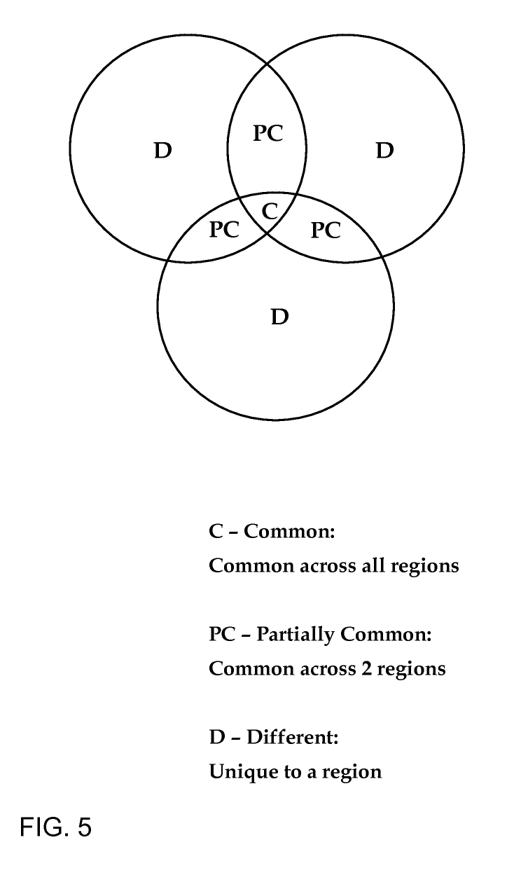

The identification of commonality in the processes being compared is then called for, as embodied in a block 404. Specifically, both those aspects of the various regional processes that have applicability across regions as well as those aspects that are already being practiced amongst the multiplicity of regions are identified and marked. A rating is then assigned to each process on the basis of such commonality as may be found, which is illustrated in a block 406. In a preferred embodiment, the commonality rating may be issued as ‘common’, ‘partially common’ and ‘different’, and the basis of such a rating is illustrated in FIG. 5.

FIG. 5 is a Venn diagram wherein each circle represents a region and depicts a process ecosystem for a particular process level in the region. The area covered by the overlap of every circle, then, may be classified as ‘common’. Similarly, the area covered by two or more circles may be classified as ‘partially common’ and the area covered by no more than one circle may be classified as ‘different’. Processes in each process level, then, are classified on the basis of their commonality rating, as in a block 408.

In a preferred embodiment, scoring may be used to mark these processes with a weightage. A cut-off score is then devised, and processes that fail to meet the cut-off score are then modified or dropped entirely. Scoring can be based on metrics such as the substantiality of value-add presented by the process, the business criticality of the process, industry practice compliance and target system fitment.

A solution for at least one previously identified pain point is then found and incorporated into the future state model, prior to rollout, as depicted in a block 410. Following such a step, requirements for each process are aligned with the strategic business objectives of the implementing organization, and the requirements that are consequently generated are attached to the future state model, as indicated in a block 412.

Referring back to FIG. 1, a final step in the implementation of a unified business model involves the normalization of the future state model across each of the regionally distributed process environments, as indicated in a block 108. In a preferred embodiment, the future state model may also be subjected to validation by one or more regional process owner groups prior to roll out across the organization. Validation is done in order to ensure clarity and buy-in for the future state model across regions. Typically, such a step involves refinement of the future state model and sign off by stakeholders involved in its subsequent implementation.

As will be appreciated by those ordinary skilled in the art, some aspects of the foregoing example, demonstrations, and method steps may be implemented by suitable code on a processor base system, such as general purpose or special purpose computer. Such code, as will be appreciated by those of ordinary skill in the art, may be stored or adapted for storage in one or more tangible machine readable media, such as on memory chips, local or remote hard disks, optical disks or other media, which may be accessed by a processor based system to execute the stored code. Note that the tangible medium of storage may comprise paper or another suitable medium upon which the instructions are printed. It should also be noted that different implementations of the present technique may perform some or all the steps described herein in different orders or substantially concurrently, that is, in parallel.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer aided method for implementing process unification across regionally distributed process environments, comprising:
establishing a common process framework;
establishing at least one present state model for the regionally distributed process environments;
establishing a future state model; and
normalizing the future state model across the regionally distributed process environments.

2. The method as claimed in claim 1, wherein the establishment of the common process framework further comprises:
classifying processes across the regionally distributed process environments into at least two process levels;
mapping a transaction flow for each of the at least two process levels using a computer; and
assigning an ownership role to each of the at least two process levels.

3. The method as claimed in claim 2, wherein the establishment of the at least one present state model further comprises:
creating a reference model for each transaction flow mapped to each of the at least two process levels, the reference model captured in a computer based template;
identifying process requirements associated with each of the transaction flows;
identifying best practices for processes within each of the at least two process levels;
identifying at least one pain point, wherein a pain point is an existing limitation within a process that is under consideration; and
drafting a final common requirements document, the final common requirements document detailing identified requirements and the at least one pain point associated with each of the at least one present state models.

4. The method as claimed in claim 3, wherein the establishment of the future state model further comprises:
collating processes in each of the at least two process levels across the regionally distributed process environments;
identifying commonality between each of the processes;
assigning a commonality rating for each process;
classifying processes in each of the at least two process levels on the basis of the commonality rating for each process;
incorporating a solution to the at least one pain point identified in the present state model into the future state model; and
aligning requirements for each of the at least two process levels with strategic business objectives, thereby generating at least one requirement for the future state model.

5. The method as claimed in claim 1, wherein the establishment of the at least one present state model further comprises:
creating a reference model for each transaction flow mapped to each of the at least two process levels, the reference model captured in a computer based template;
identifying process requirements associated with each of the transaction flows;
identifying best practices for processes within each of the at least two process levels;
identifying at least one pain point, wherein a pain point is an existing limitation within a process that is under consideration; and
drafting a final common requirements document, the final common requirements document detailing identified requirements and the at least one pain point associated with each of the at least one present state models.

6. The method as claimed in claim 1, wherein the establishment of the future state model further comprises:
collating processes in each of the at least two process levels across the regionally distributed process environments;
identifying commonality between each of the processes;
assigning a commonality rating for each process;
classifying processes in each of the at least two process levels on the basis of the commonality rating for each process;
incorporating a solution to the at least one pain point identified in the present state model into the future state model; and
aligning requirements for each of the at least two process levels with strategic business objectives, thereby generating at least one requirement for the future state model.

7. The method as claimed in claim 1, wherein there are at most five process levels.

8. The method as claimed in claim 7, wherein the five process levels are classified as levels 0, 1, 2, 3 and 4.

9. The method for implementing process unification across regionally distributed process environments as claimed in claim 8, wherein the method further comprises classifying each process in terms of a relative benefit provided by the process to a customer.

10. The method for implementing process unification across regionally distributed process environments as claimed in claim 8, wherein the method further comprises the step of classifying each process in terms of the relative value provided by the process to the process owner.

11. The method as claimed in claim 1, wherein the method further comprises identifying regional differentiators in each process in each of the regionally distributed process environments.

12. The method as claimed in claim 1, wherein the method further comprises performing a value analysis of the at least one present state model, wherein value is defined as a relative benefit provided by a process to a process owner.

13. The method as claimed in claim 1, further comprising the step of capturing at least one requirement critical to a customer in the present state model.

14. The method as claimed in claim 1, further comprising documenting a time measure for each of the at least two process levels, wherein a time measure is an indicative period of time utilized by a process within each of the at least two process levels.

15. The method as claimed in claim 1, wherein the commonality rating is selected from a group consisting of common, partially common and different.

16. The method as claimed in claim 1, wherein the method further comprises preparing a single unified future requirement set.

17. The method as claimed in claim 1, wherein the method further comprises scoring each of the at least one requirements in the future state model.

18. The method as claimed in claim 1, wherein the method further comprises driving process standardization through process owners.

19. The method as claimed in claim 1, wherein the method further comprises utilizing computer based tools to map the transaction flows associated with the future state model.

20. The method as claimed in claim 1, wherein the method further comprises retaining regional differentiators in the future state model.

21. The method as claimed in claim 1, wherein the method further comprises utilizing computer based tools to map process requirements associated with each of the present state models and the future state model.

22. The method as claimed in claim 1, wherein the method further comprises validating the future state model.
